(19) United States
(12) Patent Application Publication
(10) Pub. No.: US 2026/0031082 A1
(43) Pub. Date: Jan. 29, 2026

(54) SYSTEMS AND METHODS FOR INTERACTION DETECTION AND EVALUATION

(71) Applicant: Frontline AI, LLC, New Canaan, CT (US)

(72) Inventors: Charles Dominick Nardi, Stamford, CT (US); Robert M. Naughton, New Canaan, CT (US); Michael Shullman, New Canaan, CT (US)

(21) Appl. No.: 18/810,350

(22) Filed: Aug. 20, 2024

Related U.S. Application Data
(60) Provisional application No. 63/676,248, filed on Jul. 26, 2024.

(51) Int. Cl. G10L 15/08; G06F 40/284; H04L 12/18

(52) U.S. Cl. CPC G10L 15/083; G06F 40/284; H04L 12/1831; G10L 2015/088

(57) ABSTRACT

A system includes a computing device that includes a memory configured to store instructions. The system also includes a processor to execute the instructions to perform operations that include receiving an audio stream from a first user device, and processing the audio stream to detect one or more interactions and corresponding interaction transcripts, wherein each interaction transcript is a portion of a transcript generated for the audio stream and comprises words spoken in the interaction. For each detected interaction, processing the corresponding interaction transcript to detect at least timestamps and one or more keywords associated with the interaction. Operations also include presenting for evaluation, on a display of a second user device, data pertaining to the one or more detected interactions.

### CLAIM OF PRIORITY

This application claims priority under 35 USC § 119(e) to U.S. Patent Application No. 63/676,248, filed on Jul. 26, 2024, the entire contents of which are hereby incorporated by reference.

### BACKGROUND

This specification relates to processing and detecting data related to interactions.

A number of interactions occur each day in a variety of settings such as a workplace service, or customer facing industry. Such interactions are often complicated. Some parts of conversations may be left unsaid, for example, or many conversations may be misinterpreted based on the interaction tone or wording used during the interactions. Such gaps may lead to losses, as some issues may need to be readdressed, while other issues are missed repeatedly. Unaddressed issues can lead to the significant harm of an industry, as readdressing issues takes time, and unaddressed issues can snowball into detrimental issues for the workplace, service, or customer facing industry.

### SUMMARY

This specification describes a system implemented as computer programs on one or more computers in one or more locations that assists users in monitoring a variety of interactions. The system can streamline the supervision process for administrators (such as managers, supervisors, or employers) that wish to analyze other users within the same workplace, service, or customer facing industry.

According to a first aspect there is provided a method for receiving an audio stream from a first user device, processing the audio stream to detect one or more interactions and corresponding interaction transcripts, wherein each interaction transcript is a portion of a transcript generated for the audio stream and comprises words spoken in the interaction, for each detected interaction, processing the corresponding interaction transcript to detect at least timestamps and one or more keywords associated with the interaction, and presenting for evaluation, on a display of a second user device, data pertaining to the one or more detected interactions.

This and other systems and methods for interaction detection described herein can have one or more of at least the following characteristics.

In some embodiments, the computing-device implemented method receiving the audio stream from the first user device comprises receiving one or more segments of an audio stream at a predefined cadence from the first user device and caching the one or more segments of the audio stream in a buffer.

In some embodiments, the computing-device implemented method further comprises initiating transmission of the cached audio segments from the buffer to a database of cached audio segments.

In some embodiments, the computing-device implemented method processing the audio stream to detect one or more interactions in the audio stream and corresponding interaction transcripts comprises processing an audio segment received from the first user device using an audio transcription model to generate the transcript. The method further processes the transcript, using a language processing model, to identify portions of the transcript that comprise the one or more corresponding interaction transcripts.

In some embodiments, the computing-device implemented method processing the corresponding interaction transcript to detect at least timestamps and one or more keywords associated with the interaction comprises, for each detected interaction: 1) determining a first and second timestamp of the interaction by processing the corresponding interaction transcript using the language processing model, and 2) identifying the one or more keywords in the interaction transcript by processing a set of example keywords and the interaction transcript using the language processing model.

In some embodiments, the set of example keywords from the computing-device implemented method are selected from a predefined interaction template.

In some embodiments, the computing-device implemented method further comprises, for each detected interaction: 1) determining whether the corresponding interaction transcript comprises at least one keyword, 2) in response to determining that the interaction transcript comprises at least one keyword, identifying an interaction audio clip comprising a portion of the audio stream that pertains to the interaction, and 3) storing the interaction transcript, one or more timestamps, keywords, and the interaction audio clip in an interaction database.

In some embodiments, the computing-device implemented method further comprises determining a score for each interaction, wherein the score is indicative of a discrepancy between contents of the interaction and contents of a predefined interaction template.

In some embodiments, the computing-device implemented method presenting for evaluation, on a display of the second user device, data pertaining to the one or more interactions comprises: 1) for each interaction, presenting an identification of a user of the first user device in the interaction, a location of the interaction, and a determined score for the interaction; and 2) in response to an indication of a selection of a first interaction by a user of the second user device, presenting an interaction display comprising the corresponding interaction transcript, timestamps, one or more keywords for the first interaction.

In some embodiments, the computing-device implemented method further comprises detecting a plurality of interactions from a plurality of audio streams and presenting for evaluation, on the display of the second user device, data pertaining to the plurality of interactions.

In some embodiments, the computing-device implemented method presenting for evaluation, on the display of the second user device, data pertaining to the plurality of interactions comprises: 1) presenting a dashboard visualization comprising one or more summary statistics for the plurality of interactions; and 2) presenting an interaction table comprising data relating to each interaction in the plurality of interactions, wherein the interaction table can be filtered based on one or more criteria to present a subset of the plurality of interactions.

In another aspect, a system includes a computing device that includes a memory configured to store instructions. The system also includes a processor to execute the instructions to perform operations that include receiving an audio stream from a first user device, and processing the audio stream to detect one or more interactions and corresponding interaction transcripts, wherein each interaction transcript is a portion of a transcript generated for the audio stream and comprises words spoken in the interaction. For each detected interaction, processing the corresponding interaction transcript to detect at least timestamps and one or more keywords associated with the interaction. Operations also include presenting for evaluation, on a display of a second user device, data pertaining to the one or more detected interactions.

In some embodiments, receiving the audio stream from the first user device comprises receiving one or more segments of an audio stream at a predefined cadence from the first user device, and caching the one or more segments of the audio stream in a buffer.

In some embodiments, operations further comprise initiating transmission of the cached audio segments from the buffer to a database of cached audio segments.

In some embodiments, processing the audio stream to detect one or more interactions in the audio stream and corresponding interaction transcripts comprises processing an audio segment received from the first user device using an audio transcription model to generate the transcript, and processing the transcript, using a language processing model, to identify portions of the transcript that comprise the one or more corresponding interaction transcripts.

In some embodiments, processing the corresponding interaction transcript to detect at least timestamps and one or more keywords associated with the interaction comprises, for each detected interaction, determining a first and second timestamp of the interaction by processing the corresponding interaction transcript using the language processing model, and identifying the one or more keywords in the interaction transcript by processing a set of example keywords and the interaction transcript using the language processing model.

In some embodiments, the set of example keywords are selected from a predefined interaction template.

In some embodiments, operations further comprise, for each detected interaction determining whether the corresponding interaction transcript comprises at least one keyword. In response to determining that the interaction transcript comprises at least one keyword, identifying an interaction audio clip comprising a portion of the audio stream that pertains to the interaction, and, storing the interaction transcript, one or more timestamps, keywords, and the interaction audio clip in an interaction database.

In some embodiments, operations further comprise determining a score for each interaction, wherein the score is indicative of a discrepancy between contents of the interaction and contents of a predefined interaction template.

In some embodiments, presenting for evaluation, on a display of the second user device, data pertaining to the one or more interactions comprises, for each interaction, presenting an identification of a user of the first user device in the interaction, a location of the interaction, and a determined score for the interaction, and, in response to an indication of a selection of a first interaction by a user of the second user device, presenting an interaction display comprising the corresponding interaction transcript, timestamps, one or more keywords for the first interaction.

In some embodiments, operations further comprise detecting a plurality of interactions from a plurality of audio streams, and, presenting for evaluation, on the display of the second user device, data pertaining to the plurality of interactions.

In some embodiments, presenting for evaluation, on the display of the second user device, data pertaining to the plurality of interactions comprises presenting a dashboard visualization comprising one or more summary statistics for the plurality of interactions, and, presenting an interaction table comprising data relating to each interaction in the plurality of interactions, wherein the interaction table can be filtered based on one or more criteria to present a subset of the plurality of interactions.

In another aspect, one or more computer readable media store instructions that are executable by a processing device, and upon such execution cause the processing device to perform operations including receiving an audio stream from a first user device, and processing the audio stream to detect one or more interactions and corresponding interaction transcripts, wherein each interaction transcript is a portion of a transcript generated for the audio stream and comprises words spoken in the interaction. For each detected interaction, processing the corresponding interaction transcript to detect at least timestamps and one or more keywords associated with the interaction. Operations also include presenting for evaluation, on a display of a second user device, data pertaining to the one or more detected interactions.

In some embodiments, receiving the audio stream from the first user device comprises receiving one or more segments of an audio stream at a predefined cadence from the first user device, and caching the one or more segments of the audio stream in a buffer.

In some embodiments, operations further comprise initiating transmission of the cached audio segments from the buffer to a database of cached audio segments.

In some embodiments, processing the audio stream to detect one or more interactions in the audio stream and corresponding interaction transcripts comprises processing an audio segment received from the first user device using an audio transcription model to generate the transcript, and processing the transcript, using a language processing model, to identify portions of the transcript that comprise the one or more corresponding interaction transcripts.

In some embodiments, processing the corresponding interaction transcript to detect at least timestamps and one or more keywords associated with the interaction comprises, for each detected interaction, determining a first and second timestamp of the interaction by processing the corresponding interaction transcript using the language processing model, and identifying the one or more keywords in the interaction transcript by processing a set of example keywords and the interaction transcript using the language processing model.

In some embodiments, the set of example keywords are selected from a predefined interaction template.

In some embodiments, operations further comprise, for each detected interaction determining whether the corresponding interaction transcript comprises at least one keyword. In response to determining that the interaction transcript comprises at least one keyword, identifying an interaction audio clip comprising a portion of the audio stream that pertains to the interaction, and, storing the interaction transcript, one or more timestamps, keywords, and the interaction audio clip in an interaction database.

In some embodiments, operations further comprise determining a score for each interaction, wherein the score is indicative of a discrepancy between contents of the interaction and contents of a predefined interaction template.

In some embodiments, presenting for evaluation, on a display of the second user device, data pertaining to the one or more interactions comprises, for each interaction, presenting an identification of a user of the first user device in the interaction, a location of the interaction, and a determined score for the interaction, and, in response to an indication of a selection of a first interaction by a user of the second user device, presenting an interaction display comprising the corresponding interaction transcript, timestamps, one or more keywords for the first interaction.

In some embodiments, operations further comprise detecting a plurality of interactions from a plurality of audio streams, and, presenting for evaluation, on the display of the second user device, data pertaining to the plurality of interactions.

In some embodiments, presenting for evaluation, on the display of the second user device, data pertaining to the plurality of interactions comprises presenting a dashboard visualization comprising one or more summary statistics for the plurality of interactions, and, presenting an interaction table comprising data relating to each interaction in the plurality of interactions, wherein the interaction table can be filtered based on one or more criteria to present a subset of the plurality of interactions.

Particular embodiments of the subject matter described in this specification can be implemented so as to realize one or more of the following advantages.

As described above, a number of interactions occur each day, and it may be beneficial to evaluate such interactions. The system can analyze any number of such interactions to provide feedback on the content of such interactions, and it can be tailored to evaluate content based on a specific interaction type or based off the goals of an administrator. For example, the system could be tailored to evaluate interactions among coworkers in the workplace to determine if communication among coworkers is effective and clear regarding certain projects. In another example, the system may evaluate interactions of a customer facing industry, where it may evaluate interactions between a customer service representative and a customer. An administrator may have goals for the users of the system, as the administrator may regulate that users must be online for a set number of hours each day, or that users must have effective and positive interactions. The system may analyze interactions based on these, or other administrative goals, and it can alert administrators or users of the system when such goals are not met.

Based on an analysis of such interactions, the system can be used to train individuals. The system can also be used to evaluate a variety of individuals free from any preconceived biases, as it can uniformly evaluate the interactions of numerous individuals across various locations. The system further provides a technological improvement of a computational device, as it can automatically send alerts to an individual when there is a discrepancy of interactions detected. The system may use feedback from administrators or previous interactions to show if the interactions among specific employees, or a set of interactions across a specific industry or service location are improving or declining over time. The system can be automatically configured to initiate an action, which may inform and improve a user's performance with respect to goal related to the action. For example, if a user is inactive and is not meeting the administrator goal of being online for a set number of hours, the system can automatically send an inactivity alert to the user and/or the administrator. The system can store and analyze interactions on multiple computers across different locations, and it can incorporate its analysis onto a network, streamlining the transmission of information and the review process of numerous individuals, industries, or service locations.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example interaction that can be evaluated using an interaction evaluation system.

FIG. 2 is a system diagram of an example interaction evaluation system that includes an interaction detection engine.

FIG. 3 is a block diagram of an example interaction detection engine that uses a large language model to detect interactions.

FIG. 4 depicts an example interaction template that the interaction evaluation system of FIG. 2 can use to evaluate a detected interaction.

FIG. 5 illustrates an example display that can be used by the system to receive audio from a user.

FIG. 6 illustrates an example administrator dashboard summary display for visualizing interactions detected using the example interaction evaluation system of FIG. 2.

FIG. 7 illustrates an example interaction display for visualizing data detected for a particular interaction.

FIG. 8 illustrates an example action configuration display that can be used to configure the initiation of an action based on data detected using the example interaction evaluation system of FIG. 2.

FIG. 9 is a flow diagram of an example process for detecting and evaluating an interaction.

FIG. 10 illustrates an example of a computing device and a mobile computing device that can be used to implement the techniques described here. Like reference numbers and designations in the various drawings indicate like elements.

### DETAILED DESCRIPTION

An interaction evaluation system can evaluate a variety of interactions between a first user and an individual. For example, a first user (e.g., an employee or customer service representative) may attempt to sell a service or product to an individual (e.g., a customer) in a sale interaction. In another example, two users (e.g., two employees within the same workplace or group) interact regarding a specific project or task. Often, an administrator (e.g., a business owner, analyst, group leader, or a supervisor) may like to evaluate the content of these interactions to determine the tone of the system users or the success of the interaction for a specific goal. Through automated methods, the interaction evaluation system can record, analyze, provide feedback on the success any number of such interactions, thereby saving administrators much time.

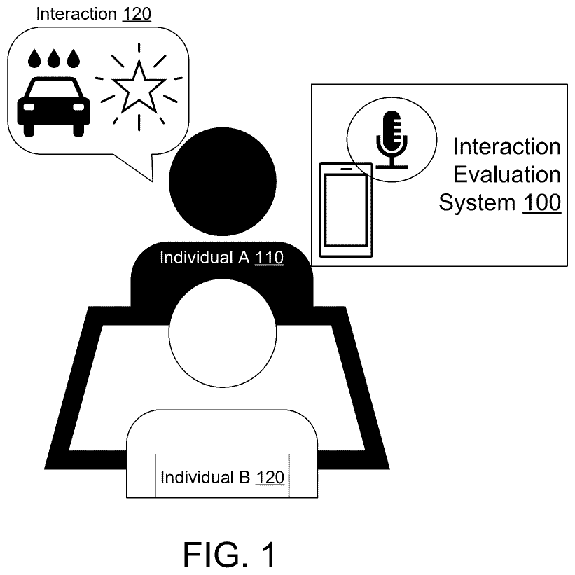

Turning to FIG. 1, an interaction evaluation system 100 can capture and process audio signals (e.g., speech). As depicted, the interaction evaluation system 100 may detect, capture, and evaluate a variety of interactions between a first system user (Individual A 110) and a second system user or individual (Individual B 120). In some embodiments, Individual A 110 may be a customer service representative (CSR) for a service (e.g., a business or customer-facing industry), and Individual B 120 may represent a customer of the service. In some implementations, Individual A 110 attempts to sell a commercial service to Individual B 120 (for example, a subscription service or product). Individual A 110 may use several sales tactics to convince Individual B 120 to buy the commercial service. In some implementations, these sales tactics may be recommended to Individual A 110 by their administrator, or Individual A 110 may receive a series of talking points or a script from their administrator to sell the desired service.

In one example scenario, Individual A 110 is an attendant at a car wash business, and they attempt to sell a subscription service for regular carwashes to Individual B 120, either over the phone or in person at the car wash. Before the interaction, Individual A 110 received a script with a few talking points to sell the subscription service. Individual A 110 may have also received various quotas from their employer. For example, the employer may want Individual A 110 to make a minimum number of sales per month, or they might regulate that Individual A 110 must be online speaking with customers for a set number of hours each day. Rather than recording each CSR/customer interaction, the car wash employer chooses to use the interaction evaluation system 100 to automatically detect, capture, and analyze any number of interactions between their employee (Individual A 110) and any number of potential customers (Individual B 120). The interaction evaluation system 100 may help the administrator or employer determine whether Individual A 110 meets the desired quotas and/or whether Individual A 110′s sales tactics towards Individual B 120 and other customers are successful.

The system may also be used within a group or workplace. The system may be used to evaluate conversations among individuals (e.g., among employees) within the workplace or group on a number of different topics. For example, the system might evaluate the sentiment content of interactions to determine the overall tone of individuals in the group (e.g., are coworkers friendly to one-another? Is there any animosity or are there harmful dynamics within the group?). The system might also evaluate the success of interactions within the groups based on an administrator's goals (e.g., are users effectively communicating with one another? Do users correctly understand their assigned project, and do they clearly communicate about the needs of the project to other users?).

In another example scenario, Individual A 110 is an employee at a software company, and they attempt to discuss next steps for a software coding project with Individual B 120, who is another coworker assigned to the project. At a software company, attention to detail is very important, as missed details during technological interactions, or misunderstandings can lead to significant losses in time and productivity. Before the interaction between Individual A 110 and Individual B 120, their supervisor updated the system with information about the project and asked it to analyze the interactions between Individual A 110 and Individual B 120 related to their assigned project. The supervisor asks the system to determine whether any information about the project was missed during their interactions, whether their interactions are productive, if the individuals accurately understand the tasks required for the project, and how much time each individual is spending on the project.

While a car wash service and a workplace interaction were described above, the interaction evaluation system 100 can capture and analyze other interactions between Individual A 110 and Individual B 120. The interaction evaluation system 100 may analyze the content of the interaction between Individual A 110 and Individual B 120, and it may also analyze other metrics desirable to administrators. For example, as described above, administrators (e.g., an employer) may like to know how often users (e.g., Individual A 110) are online, or they may like to know how many interactions between users (e.g., their employees) and individuals (e.g., customers) led to a successful sale of a service. Administrators might also like to evaluate other metrics of the system users, such as their tone towards other system users or individuals, or their wording during service, workplace, or group interactions. The interaction evaluation system 100 may provide an automated analysis of such quotas, which streamlines the evaluation process of employees or other users. In a conventional evaluation process, an administrator, may need to record, listen to, sort, and analyze numerous interactions between their employees and customers. If an administrator is responsible for multiple services across multiple locations, and each service must always record during regular business hours (e.g., 9-5), this may result in over 24 hours of recording that must be reviewed and evaluated in a day. Evaluating such content may be difficult with conventional evaluation methods.

Some administrators have a conscious or unconscious bias towards various system users and individuals, often stemming from preconceived biases in race, gender, or socioeconomic status, among others. Such biases may cause administrators to evaluate some interactions (e.g., CSR-customer or employee-employee interactions) more than others, which may lead to an unjust negative evaluation of some users. Alternatively, if a service has different locations, different administrators may employ different evaluation methods for users. While one administrator may view an interaction favorably, another administrator may view the same interaction critically based on personal preferences of tone or sales tactics used during interaction. On the other hand, some administrators may be biased towards their service location, or they may be biased to evaluate their user interactions more favorably if they are competing with other locations of the same service. These discrepancies, combined with potential administrator bias, make it difficult to provide a fair manual assessment of user quotas and interaction skills.

The automated interaction evaluation system 100 provides many advantages over the conventional techniques. The interaction evaluation system 100 may evaluate any number of interactions within, across service locations, etc., and can evaluate a considerable number of interactions in a day. The interaction evaluation system 100 may have a uniform evaluation system to evaluate interactions free from most preconceived biases. This uniform evaluation system allows for the simple automated evaluation of system users within a service location, which easily allows administrators to determine their employee quotas and asses their service goals. The system may sort through interactions and associate interactions with specific employees or service locations. The interaction evaluation system 100 may also allow users to compare quotas across different service locations without fear of bias from administrators in some locations. The interaction evaluation system 100 may provide fast feedback, which allows an administrator to deploy a corrective action faster. A corrective action may include sending messages, alerts, etc. and it may utilize one or more types of information distribution systems such as text message systems, email message systems, etc. A corrective action may also include speaking with an employee, changing a sale method of a service or product, adjusting product prices, or determining new strategies to improve services or communications across different locations. With a quicker corrective action, an administrator can fix an issue before it causes significant harm to their service. Furthermore, while conventional techniques miss some large interaction issues if they could not evaluate every interaction, the automated interaction system 100 may evaluate all desired interactions, taking every issue into account.

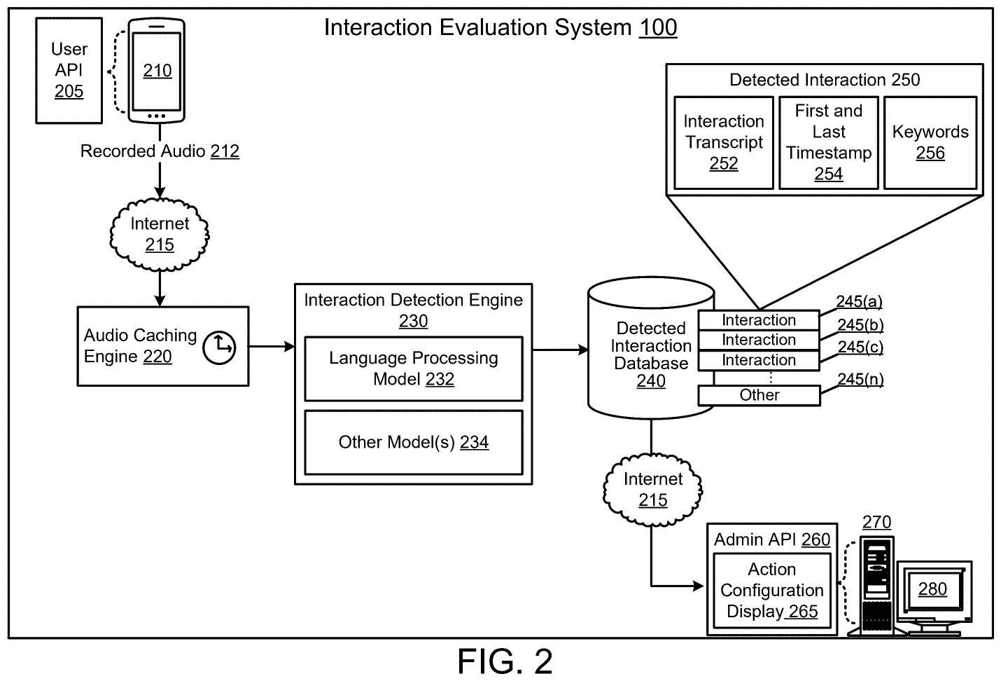

As described above, FIG. 1 depicts an example where the interaction evaluation system 100 is used for an interaction between two individuals. FIG. 2, presents an example of a more detailed process of interaction evaluation system 100. Interaction evaluation system 100 is an example of a system implemented as computer programs on one or more computers in one or more locations. The system can incorporate its analysis onto a network, streamlining the transmission of information and the review process of numerous individuals, industries, or service locations. While the car wash business and software company examples were described as potential users of the interaction evaluation system 100, it should be understood that any customer facing industry (e.g., food, auto, travel, entertainment, clothing, sporting events, etc.) or any industry requiring training or evaluation (e.g., medical, fire, police, health care, sales, education, home improvement, etc.) may benefit from such a system.

The second user (often referred to as an administrator) of the interaction evaluation system 100 described in FIG. 1 may be an employer, supervisor, business owner, or the administration of a group within one or more of the industry examples described above. The second user may be evaluating one or more first users (e.g., one or more employees of the group), wherein the one or more evaluated first users are not necessarily in the same location. For example, a second user may be evaluating a group of first users across two or more locations of the same service. In some implementations, a first user of evaluation system 100 may be an employee, and a second user of the system is an administrator, who receives an analysis of the first user from the evaluation system 100.

As shown in FIG. 2, the interaction evaluation system 100 may be integrated into a user application programming interface (API) 205, wherein the API is be integrated into a first user device such as a point of sale (POS) device 210. The POS device may be tablet, phone, or another device where an individual (e.g., a customer) may provide payment for a service. The API 205 may enable the POS device 210 to collect recorded audio 212. In some implementations, the user of the POS device 210 may manually start recording audio, or the API 205 may automatically detect the beginning of an interaction from the user, and it may automatically start recording to collect recorded audio 212. In some implementations, the system is instructed to evaluate interactions between a user of the first user device 210 and another individual (e.g., a customer).

The recorded audio 212 may be sent over the internet 215 to an audio caching engine 220. The audio caching engine 220 creates audio segments of the recorded audio stream 212 so the interaction detection engine 230 can further process the audio. In some implementations, the audio caching engine 220 receives one or more segments of a recorded audio stream 212 at a predefined cadence from the first user device 210 and caches the one or more segments of the audio stream in a buffer. Audio caching may occur through a variety of buffers, with a buffer of every 15 minutes in some implementations. It should be understood that caching can occur in greater or smaller segments/buffers. The audio caching engine 220 may create a transcript of the recorded audio stream 212 before caching the audio, or the audio caching engine 220 may create a transcript after the audio is segmented. In some implementations, the audio caching engine only outputs the cached audio segments and does not produce a transcript. After the audio is cached, the audio caching system may initiate transmission of the cached audio segments from the buffer to a database (e.g., interaction detection engine 230) of cached audio segments.

The segmented audio streams from the audio caching engine 220 are then processed by the interaction detection engine 230 to detect one or more interactions. The interaction detection engine 230 may employ tools such as an audio transcription model to generate a transcript from the cached audio recording segment.

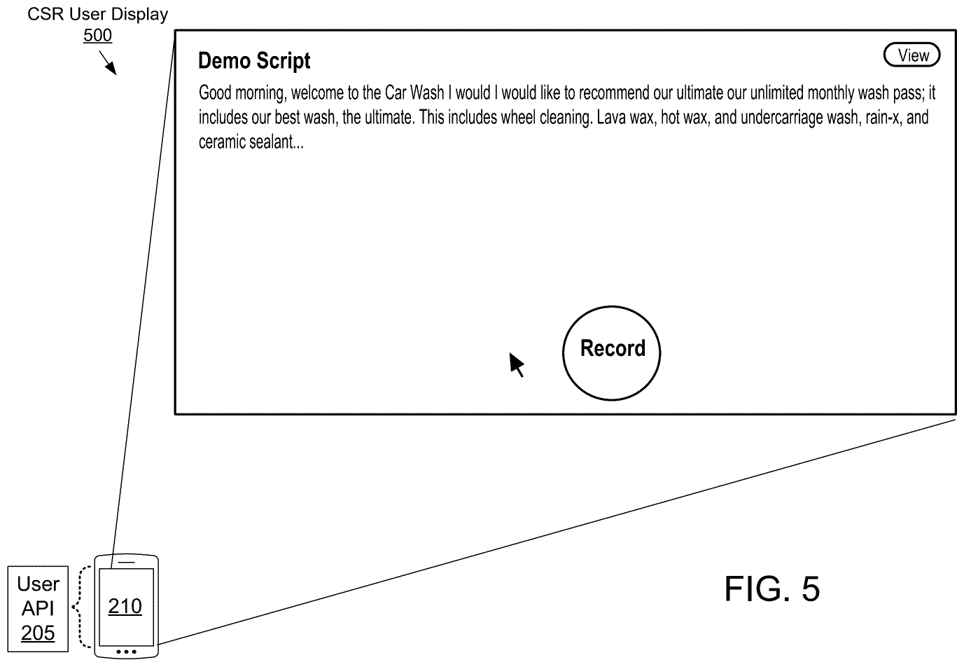

The interaction detection engine 230 may also employ a language processing model 232 or other model(s) 234 to process the transcript and identify portions of the transcript that correspond to the one or more corresponding interaction transcripts. The corresponding interaction transcript may be a portion of the overall transcript, wherein the corresponding interaction transcript only includes the transcript of a detected interaction. In some implementations, a language learning model, the language processing model 232 or other model(s) 234, detect the corresponding interaction transcript, timestamps (e.g., a first and last timestamp) of a specific interaction, and the keywords of each interaction. In some implementations, the language processing model 232 or other model(s) may use a predefined interaction template or keywords to evaluate the transcript of the identified interaction. In an example, the system may be instructed to evaluate employee interactions when they attempt to sell a car wash subscription service to customers. The system may use an interaction template, which identifies keywords such as “car wash subscription”, “tiered pricing model”, “premium subscription” for the models to search. The employee may be instructed to use a template as a guide when selling the service, and they may be provided with a demo script and keywords to use during their service interaction. The models may evaluate the interaction by comparing the interaction transcript to the corresponding interaction template and keywords. The corresponding interaction transcript (or demo script) is described in further detail in FIG. 5.

The other model(s) 234 may be configured to process the audio to generate useful information with respect to the interaction. In an example, the other model(s) 234 may include a sentiment model for Individual A 110 (e.g., an employee or CSR) and Individual B 120 (e.g., another employee or a customer) in the interaction. The sentiment model may determine if there is any important information displayed from the reaction of the individuals, such as an individual expressing confusion or an indication that the sale was successful. The other model(s) 234 may additionally or alternatively include a pitch and inflection model, where the model may use non-interaction data to determine user sentiment, detect any incidents at the service location, and monitor theft.

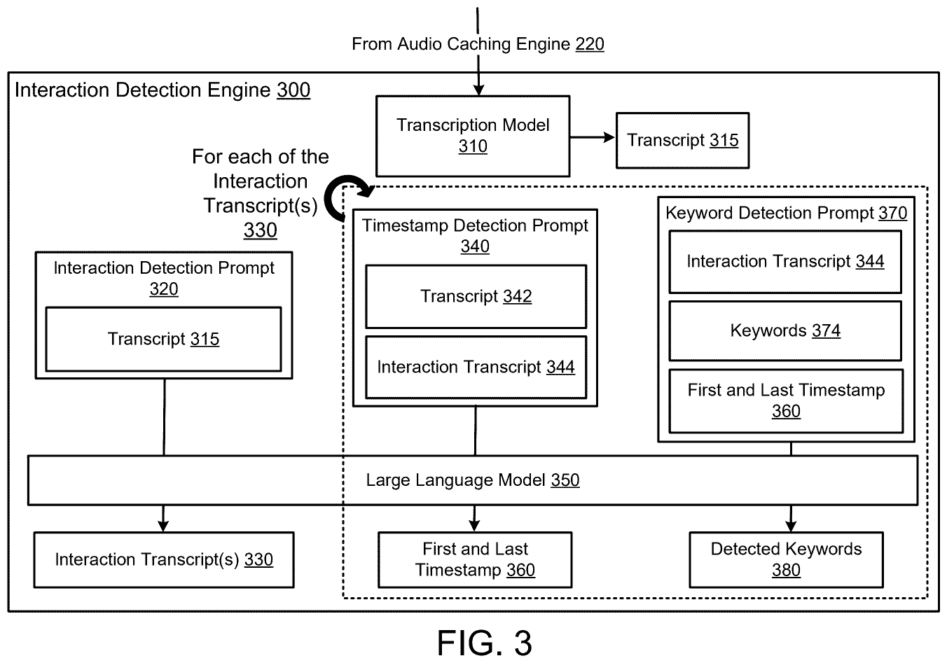

The corresponding interaction transcripts may identify the type of interaction and help determine that one or more interactions have occurred in the recorded audio streams 212. The interaction detection engine 230 processes the segmented interaction transcripts, wherein each interaction transcript from the audio caching engine 220 is a portion of the transcript generated from the original recorded audio stream 212 and comprises words spoken in the interaction. In some implementations, the interaction detection engine 230 may output interaction transcription text with text segments that define timestamps when key phrases or words are mentioned. The detection process of interaction detection engine 230 will be described with further detail in FIG. 3.

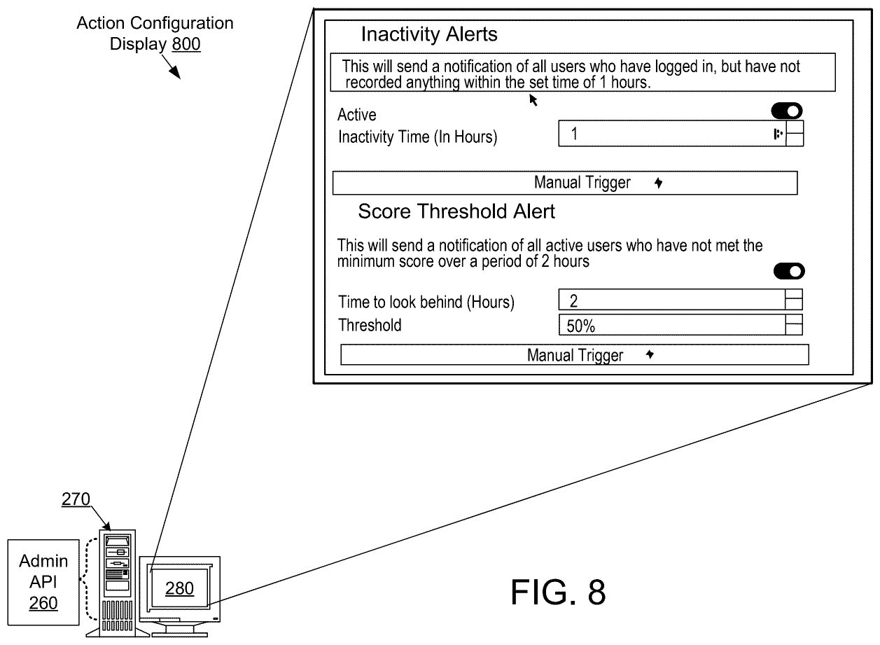

As stated above, the interaction detection engine 230 sends an output (such as an interaction transcription text, or text segments that define timestamps and key phrases) to the detected interaction database 240, which stores the interactions 245. The interactions 245 store detected interactions 250 with information related to interaction transcript 252, first and last timestamp 254, and keywords 256. As described in more detail above, the automatic storing of detected interaction data saves users time, as an administrator can easily locate the timestamps of relevant interactions without manually searching through the audio transcript. The transcript 252, first and last timestamp 254, and keyword 256 information may be sent via the internet 215 to a second user device (e.g., an administrator's device) 280 for presentation and evaluation. Data pertaining to the one or more detected interactions may be displayed, through one or more computational device(s) 270 (e.g., a server, computer, or other device), using an admin API 260 or an action configuration display 265 on the second user device 280. The action configuration display is described in further detail in FIG. 8.

In one embodiment, the system receives an audio stream from the first user device 210, processes the audio stream to detect one or more interactions 250 and corresponding interaction transcripts 252, wherein each interaction transcript is a portion of a transcript generated for the audio stream and comprises words spoken in the interaction. For each detected interaction, the system processes the corresponding interaction transcript to detect at least timestamps 254 and one or more keywords 256 associated with the interaction; and presents for evaluation, on a display 265 of the second user device 280, data pertaining to the one or more detected interactions.

As described above, the interaction detection engine 230 may employ a language processing model 232 or other model(s) 234 to generate and process a transcript, identify portions of the transcript that correspond to the one or more corresponding interaction transcripts, identify the first and last timestamp of specific interactions within the transcript(s), and identify keywords of each detected interaction. The language processing model 232 or other model(s) 234 may be instructed to detect various information in the segmented audio transcript received from the audio caching engine 220. The models 232 and 234 may be provided a variety of templates to identify different interactions. For example, some interactions may relate to customer service, while others may relate to the sale of a specific product or service. The templates may provide the models with one or more keywords to identify the interaction type. The models 232 and 234 may be instructed to identify interactions using common phrases, by searching for the topics discussed in the interactions, or by identifying keywords provided by the templates. Then, they may be instructed, for each identified interaction, to identify specific timestamps when the keywords are mentioned in the audio recording. The models 232 and 234 may also be asked to identify and list one or more keywords discussed in the interaction.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

The interaction detection engine 230 can have any appropriate machine learning architecture, e.g., a neural network, that can be configured to process an input transcript and embed the transcript in the embedded detection engine. In particular, the interaction detection engine 230 can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers).

In some cases, a language processing model 232 is a generative model, e.g., a generative-adversarial network or an autoregressive language processing network. As an example, the language processing model 232 can have a recurrent neural network architecture that is configured to sequentially process the contents of the input transcript and trained to perform next element prediction, e.g., to define a likelihood score distribution over a set of next elements. More specifically, the language processing model 232 can be a recurrent neural network (RNN), long short-term memory (LSTM), or gated-recurrent unit (GRU). As another example, the language processing model 232 can be an encoder-decoder transformer configured to perform parallel processing of the contents of the multimodal input using a multi-headed attention mechanism.

As a particular example, the language processing model 232 can be a foundation language processing model, e.g., a foundation model such as a transformer large language model. Large language models have been demonstrated to achieve state of the art performance in semantic understanding, e.g., their ability to effectively capture semantic information from inputs. In this case, the input transcript can include training data formulated as prompts.

In this case, the language processing model 232 or other model(s) 234 can be trained on a set of training examples, e.g., where each training example corresponds to a respective training transcript and includes a training model input and target output. In particular, the system can train the interaction detection engine 230, e.g., by updating the respective values of parameters of the model, e.g., using the update rule of any appropriate gradient descent optimization algorithm, e.g., RMSprop, or Adam.

Turning to FIG. 3, the interaction detection engine 300 receives a cached audio segment from audio caching engine 220. As described in more detail above, the cached audio may be segmented audio recordings, wherein the audio may be segmented in 15-minute intervals. The interaction detection engine 300 employs a transcription model 310 to generate a transcript 315 of the cached audio. The transcription model 310 may use Google, ChatGPT audio to text model examples, or other transcription tools. In some implementations, the transcription model 310 may search for an opening interaction in the audio, such as “hello” or at least one keyword before beginning a transcription. After the transcription model 310 generates a transcript 315 of the cached audio, the interaction detection engine 300 may provide the language processing model 232 or other model(s) 234 described in FIG. 2 above with a series of engineered prompts. The engineered prompts include an interaction detection prompt 320, a timestamp detection prompt 340, and a keyword detection prompt 370. FIG. 3 depicts the integration of a large language model 350 to process prompts 320, 340, and 370. It should be understood that the interaction detection engine may employ large language model 350, transcription models, language processing models, or other models to complete the tasks described below. The large language model 350, language processing model 232 or other model(s) 234 used to process tasks will be referred to as “the models” in the following paragraphs describing the interaction detection prompt 320, timestamp detection prompt 340, and keyword detection prompt 370.

The interaction detection prompt 320 may use the models to identify one or more interactions in the cached audio by providing engineered prompts or instructions to the models. The models in the interaction detection prompt take the cached segmented audio transcript 315 as an input and produce separate segmented interaction transcripts 330 as an output. In some implementations, the interaction detection prompt 320 may provide the models with a list of keywords to identify in the transcription 315 from the segmented audio. The models may receive information about the type of conversations that took place in the transcription 315 (e.g., an interaction between a salesperson and a customer), and the purpose of the interaction (e.g., to sell a company subscription service). The models may be assigned a goal (e.g., to identify each distinct sales interaction within the conversation). The models may also be given criteria to determine that a sales interaction took place, as they may be instructed to find interactions where the salesperson greets customers with one or more of the provided keywords, or to identify common phrases. The models may also be instructed to focus on certain aspects of the conversation, or to exclude certain conversations that are not of interest to the user.

For example, the models may be asked to discern and document where the salesperson engages in efforts to sell the product by using the provided criteria (like keywords) to determine what constitutes a sale interaction. In another example, the model may be asked to focus on interactions relating to the sale of a specific product or service, while excluding other interactions. The models may be instructed to locate the end of an interaction through common ending phrases, such as “thank you for your time” or “we appreciate your business.” In some implementations, the models may use an estimated time to search for interactions. For example, many interactions take place between thirty seconds and five minutes, and the models may determine that an interaction has taken place based on the interaction length. In other embodiments, the models may be instructed to detect the language of the interaction and translate the interaction to another desired language.

As multiple interactions may have taken place between various customers and the employee during a 15-minute cached audio recording received from the audio caching engine 220, the models may be instructed to report back only the transcript or details of desired interactions in each script. Alternatively, the models may be instructed to report back separate segmented transcripts for each detected interaction in the script. As a result, the models may process and segment transcript 315, such that the interaction detection prompt 320 returns segmented interaction transcripts 330 of each detected interaction. Many prompt examples have been described, but it should be understood that the models may be provided with further or alternative instructions by the interaction detection prompt 320 to translate the interaction, determine whether a sales interaction has started/ended, or to segment the transcript 315 into smaller interaction transcript(s) 330. The transcript 315 may represent cached audio segments of the overall interaction recording. As a result, the transcript 315 may include periods of silence, unrelated conversations among users, or other background noise unrelated to the desired interaction analysis. The models can use engineered prompts to exclude such non-interaction data and to focus on or extract interaction specific data.

The timestamp detection prompt 340 may use the models to analyze an input of the one or more interaction transcript(s) 330 from the interaction detection prompt 320 to produce a first and last timestamp 360 for each of the interactions. To produce a first and last timestamp 360 for each of the detected interactions in the interaction detection prompt, the models may identify keywords or phrases indicating the beginning and end of the interaction in the interaction transcript 344. Once these keywords or phrases are identified for each detected interaction, the models search a transcript 342 to determine a first and second timestamp of the interaction by processing the corresponding interaction transcript 344 using the language processing model or large language model 350. A first timestamp may correspond to the beginning of an identified conversation, and a second timestamp may correspond to the end of an identified conversation. The transcript 342 may be similar to transcript 315, or the transcript 342 may be different from transcript 315. In some implementations, one of the transcripts 342 or 315 may include timestamp information corresponding to words spoken in the cached audio recording. Alternatively, the transcript 342 may include timestamp information corresponding to the shorter interaction transcripts 330. The corresponding interaction transcript 344 may correspond to one of the interaction transcripts 330. In some implementations, numerous interaction transcripts 330 are detected from the entire transcript 315. The transcript 315 is segmented by the large language model 350 or other model(s) into specific interaction transcripts 330 using the interaction detection prompt 320. Next, one of the detected interaction transcripts 330 are selected and used as a corresponding interaction transcript input 344 for the timestamp detection prompt 340 and/or keyword detection prompt 370. In some implementations, the corresponding interaction transcript 344 is the same as the selected interaction transcript 330, or they may be different. For example, one of the corresponding interaction transcripts 344 or selected interaction transcripts 330 may contain information about timestamps correlated to words spoken during the interaction.

The keyword detection prompt 370 may use the models to analyze an input of the one of the interaction transcripts 344, the first and last timestamp 360, and keywords 374. For each identified interaction, the models may use this input information to identify one or more detected keywords 380 in the interaction transcript 344 by processing a set of example keywords 374 and the interaction transcript 344 using the language processing model or large language model 350. In some implementations, the set of example keywords are selected from a predefined interaction template. As stated above, an interaction template can define a variety of interactions. For example, a template related to a subscription service may include keywords such as “subscription”, “monthly”, “yearly”, etc. A template related to a sale conversation for a specific product may include keywords, key concepts, or phrases defining the price, name, and use of the product. An administrator may select which template or interaction type they would like to analyze, and the models may identify these interactions by searching for the template keywords and phrases in the transcript.

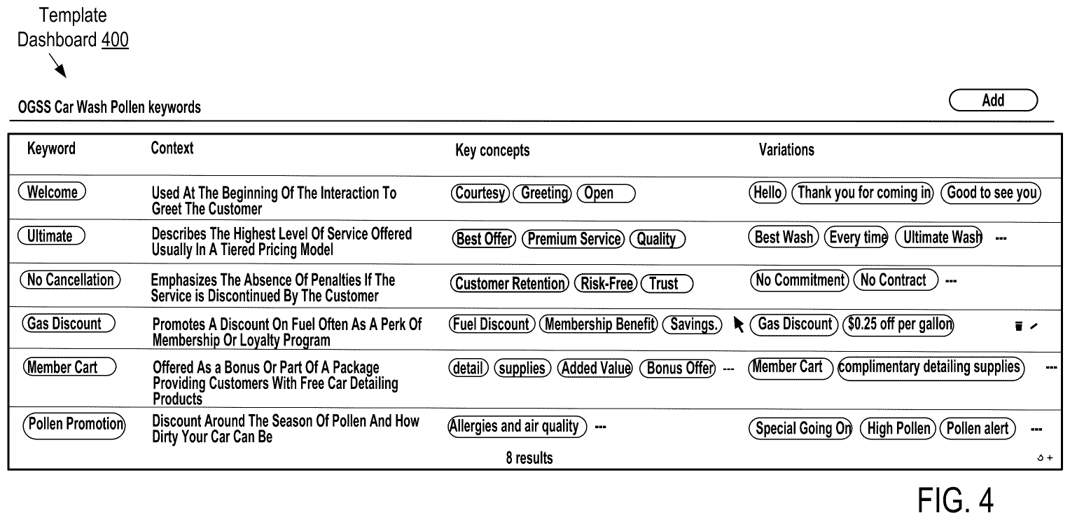

In some implementations, the keyword detection prompt 370 instructs the models to search directly for the identifying keywords, concepts, and phrases, and/or for variations of these keywords, concepts, and phrases. The keyword detection prompt 370 may also instruct the models to conduct a ‘fuzzy search’ of the key concepts, wherein the models may search for words or phrases matching the meaning of the specified keywords or phrases. The words of phrases from the fuzzy search do not necessarily share the same wording as the identified keywords, phrases, or concepts from the template. The keyword detection prompt 370 may further instruct the models to determine if a detected interaction ‘passes’ or ‘fails’ to match a specified interaction type based on the instructions or defining criteria provided in prompt 370. In some implementations, keyword detection prompt 370 may instruct the models to determine a score for each interaction transcript 330, wherein the score is indicative of a discrepancy between contents of the interaction and contents of a predefined interaction template. The system may also determine if the detected interaction transcript sufficiently matches an interaction type by determining which percentage of template keywords, phrases, or concepts are mentioned in the transcript. For example, if the interaction transcript includes only half of the keywords, key concepts, or phrases from the template, the models may determine that the interaction type fails to sufficiently match the defined interaction type in the template. If more than half of the keywords, key concepts, or phrases are mentioned from the template, the models may determine that the interaction ‘passes’ and that the interaction belongs to the interaction type of the template. While a fifty percent passing rate for interaction identification is described, it should be understood that the passing rate may be higher or lower. The template and keywords are further described in FIG. 4, which displays an example of a template dashboard for administrative use.

In other implementations, the keyword detection prompt 370 and/or timestamp detection prompt 340 instructs the models to score a sentiment of the first user (e.g., an employee or CSR) and another individual (e.g., a customer. The sentiment score may score the tone of the first user and/or the other individual. For example, the system may evaluate how friendly the first user is to an individual, and it may evaluate how this tone is received by the individual. Is the individual friendly to the first user? Is the individual responsive to the sales tactics employed by the user? Does the individual respond negatively to any keywords used during the interaction? Overall, the system may determine a sentiment of the other individual for the interaction and determine a score for the interaction based at least on the sentiment of the other individual. This score may help employers determine which sentiments, tones, or sales tactics that an individual responds to the best.

In some implementations the timestamp detection prompt 340 and/or the keyword detection prompt 370 may determine whether the corresponding interaction transcript 344 comprises at least one keyword, and, in response to determining that the interaction transcript comprises at least one keyword, the models may be instructed to identify an interaction audio clip comprising a portion of the audio stream that pertains to the interaction. The models may identify the location of the audio clip using the first and last timestamp 360 corresponding a specific interaction. The models may generate the audio clip by clipping the original cached audio received from the audio caching engine 220 based on the one or more timestamps. The models may also be instructed to store the interaction transcript, one or more timestamps, keywords, and the interaction audio clip in an interaction database, such as the detected interaction database 240 described in FIG. 2. In some implementations, the audio clip may be padded with an interaction buffer of +/−5 seconds, wherein the audio is clipped with five seconds of audio before and/or after the identified interaction based on the first and last timestamp 360. While a five second interaction buffer is described, it should be understood that the audio buffer may be longer or shorter. This audio clip may be stored in the detected interaction database 240, and it may be further sent to a second user device 280 where an employee and/or manager may access and review the clip. This incorporation of human review in the feedback loop of interaction detection provides increased flexibility, as administrators can easily determine if corrective action is needed for employees based on the content of the audio clips.

The interaction detection prompt 320, timestamp detection prompt 340, and keyword detection prompt 370 may remain unchanged, or they may be updated. For example, if a user determines that new keywords might be helpful to identifying an interaction, they may be added into prompts 320, 340, and 370. A user may also incorporate new prompts or new templates if they wish to identify a new interaction type.

After identifying the interaction type, the system may assign a score, or a “pass” or “fail” to the interaction. As described above, if a user mentions less than half of the keywords from a transcript, the system may assign a “fail” to the interaction. Alternatively, the system may assign a “fail” to an interaction if a user fails to sell a service to an individual. In some implementations, the system may be instructed to assign a pass or fail to determine if the interaction sufficiently matches a template or prompt description. Based on the number of “pass” or “fail” scores determined by the models to denote whether an interaction matches the prompt description, a user may alter the prompt if they receive a very high pass or fail rate, as this may indicate that the prompt is inadequately identifying interactions.

As described above, a user may define a set of example keywords selected from a predefined interaction template, wherein an interaction template can define a variety of interactions (e.g., a sales or customer service interaction). FIG. 4 depicts an example of a template dashboard 400 where an administer or user can set up such a template. In FIG. 4, the exemplary template relates to a car wash subscription service.

In an example scenario, a customer service representative (CSR) may be instructed to sell a car wash subscription service called “Pollen Wash.” As shown in FIG. 4, an administrator or user can set up a template to define a sale interaction for the ‘Pollen Wash” service, wherein the template dashboard 400 may include keywords, context for the keywords, key concepts for the keywords and context, and variations of the keywords. The administrator or user may add or edit relevant keywords, context, concepts, or variations using the ‘add’ button in the top right of the template dashboard 400. In other implementations, an LLM may define one or more of the keywords, context, concepts, or variators. In some implementations, the user or an LLM may set a pass/fail threshold for interaction detection engine 300 to determine whether a detected interaction sufficiently matches the interaction of the template. The models of the interaction detection engine 300 described above may use template dashboard 400 to search for these keywords or concepts in an interaction transcript. Furthermore, an administrator may provide such templates to an employee or a CSR and instruct them to use the template as an interaction guide. A CSR may also be instructed to use specific keywords in the template during a sales conversation with the customer. In other implementations, a CSR may be instructed to sound more personable by discussing specific concepts or variations of keywords rather than using the template as a script. The models may identify the interaction type by analyzing the keywords mentioned in the transcript after the conversation is completed, or by analyzing a combination of keywords and concepts listed in the conversation.

In an example scenario, the “Pollen Wash” is a car wash subscription service with a tiered pricing model, wherein a ‘ultimate’ premium service may be priced higher than a standard ‘best wash’ service. Pollen Wash may offer a variety of benefits to subscribers, such as no cancellation fees or a gas discount. In some scenarios, the attendant may be instructed to convince the customer of various service benefits (e.g., offering a bonus of other free services, or promoting the service for allergy relief during seasons with high amounts of dust or pollen). Selected key words or phrases for an interaction template relating to the Pollen Wash sales conversation may include: “Pollen Wash”, “car wash subscription”, “no cancellation fees”, “gas discount”, “member cart”, or “pollen promotion”, among other identifying keywords.

FIG. 5 presents an example of a CSR User Display 500. The CSR User Display 500 may be integrated into a user application programming interface (API) 205, wherein the API is integrated into a first user device such as a point of sale (POS) device 210. The POS device may be a tablet or a cellphone. The CSR User Display 500 displays a demo script for a sales interaction on the tablet or cellphone, either through an API or a browser. A user, such as a CSR, may be instructed to read the script or to touch on concepts in the script during a sales interaction with another user, such as a customer. A user or CSR may also be instructed to press ‘Record’ for each interaction with another user, or for all hours they are working or using the API. For example, a CSR working from 9 AM to 5 PM may start recording at 9 AM and stop recording at 5 PM. The models described above can identify each interaction within these hours and exclude irrelevant recordings where no interaction occurs, or where the CSR is on a break. The user device may record with an integrated microphone, or the CSR may record using an external microphone. In some implementations, a user or CSR may select a template script from a variety of interaction templates before recording.

Once the ‘Record’ button is pressed, it may become a ‘Stop’ button as audio is captured. In other implementations, the CSR User Display 500 is an active script during an interaction, and it may display real-time script suggestions based on the interaction. After recording, a user or administrator may see the history of what they recorded. A user such as a CSR or an employee who completed a recording may be provided information, such as where their interaction passed or failed the set interaction standard defined by an administer. They may also be shown whether they used any keywords from the template, as well as how many keywords they used. In some implementations, a user may be provided with feedback on their interactions, such as feedback on their tone and wording. Feedback may be provided manually by their administrator after reviewing interactions, or automatically by an LLM or another model.

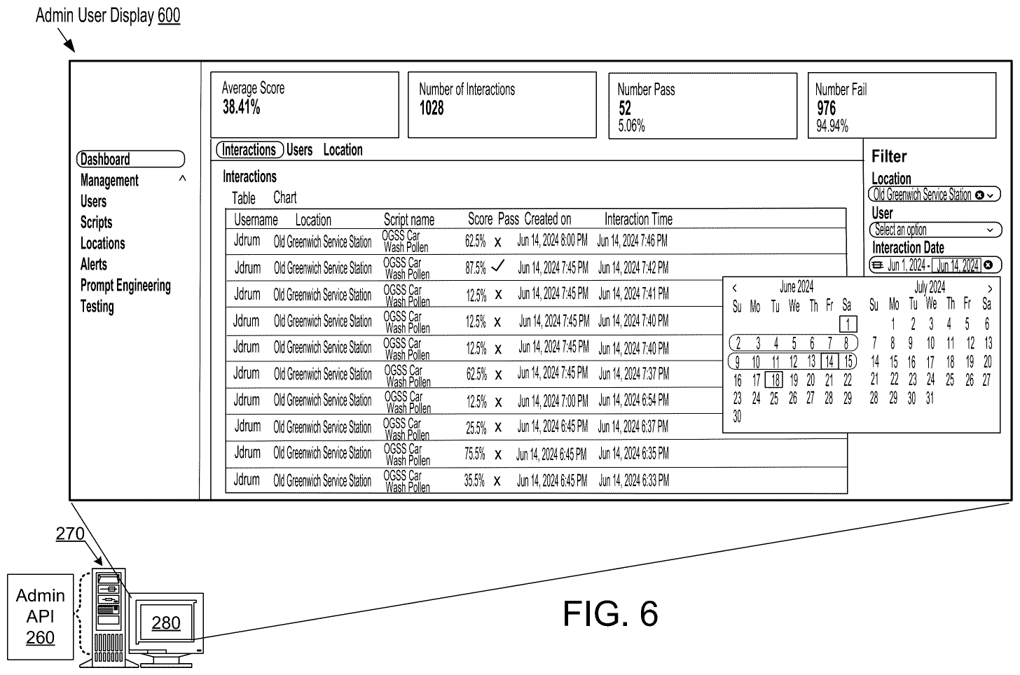

FIG. 6 presents an example of an Admin User Display 600. The Admin User Display 600 may be displayed by a user application programming interface (API) 260, wherein the API is integrated into a second user device 280 through one or more computational device(s) 270. The interaction detection engine or models described above detect a plurality of interactions from a plurality of audio streams. Data pertaining to these interactions may be presented for evaluation on the admin user display dashboard of the second user device 280.

The Admin User Display 600 may present a dashboard visualization comprising one or more summary statistics for the plurality of interactions. For example, an administrator can view overall statistics related to the total interactions, or they can view specific interactions of each employee. In some implementations, the Admin User Display 600 may display graphs to summarize interaction statistics, such as the number of interactions, proportion of interactions that resulted in a sale, the breakdown of interaction types, etc. In some implementations, the Admin User Display may present an interaction table comprising data relating to each interaction in the plurality of interactions, wherein the interaction table can be filtered based on one or more criteria to present a subset of the plurality of interactions.

The exemplary Admin User Display 600 identifies the total number of interactions, the number of interactions that “passed” a set threshold, the number of interactions that “failed” a set threshold, and an average score. The average score may represent an average of the proportion of keywords from a template of keywords used during a plurality of interactions.

The exemplary Admin User Display 600 displays data of one or more interactions. For each interaction, Admin User Display 600 presents an identification of a user of the first user device in the interaction, a location of the interaction, and a determined score for the interaction. In response to an indication of a selection of a first interaction by a user of the second user device, Admin User Display 600 presents an interaction display comprising the corresponding interaction transcript, timestamps, one or more keywords for the first interaction. The Admin User Display 600 may further display the interaction score, the pass/fail status of the interaction, the date of the interaction, and the interaction time. Optionally, the administrator can filter, e.g., by date, employee, or template, to view a different subset of the detected interactions. An administrator can also filter by dates to see how results changed over time.

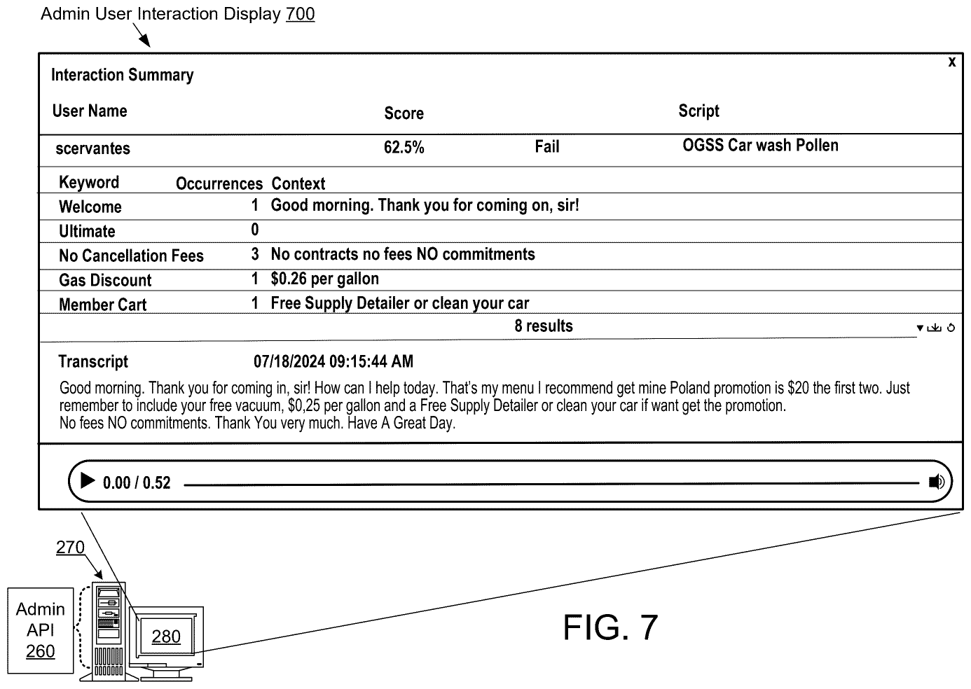

Turning to FIG. 7, a user or administrator may reach the Admin User Interaction Display view 700 by selecting an interaction from the plurality of interactions in the Admin User Display 600. The Admin User Interaction Display 700 may be displayed by a user application programming interface (API) 260, wherein the API is integrated into a second user device 280 through one or more computational device(s) 270. The Admin User Interaction Display view 700 provides additional details about the selected interaction. As stated above, the general Admin User Display 600 presents an identification of a user of the first user device in the interaction, a location of the interaction, a determined score for the interaction, the corresponding interaction transcript, timestamps, and one or more keywords for the first interaction. The Admin Interaction Display view 700 lists displays similar information, and further lists the occurrences of keywords during the interaction, the interaction transcript, and provides the audio clip of the interaction, as detected by the interaction engine.

An exemplary Action Configuration Display 800 is described in further detail in FIG. 8. The Action Configuration Display 800 can display a variety of alerts to signal a user or administrator. The alerts may be location and employee specific, allowing administrators to easily diagnose and correct issues of underperformance or inactivity. The Action Configuration Display 800 may send configurable alerts for underperformance, with two examples being an inactivity alert and a score threshold alert. The inactivity alert may be displayed for a first user/employee/CSR if they log into the system, start recording, but do not participate in any interaction for a specified period of time (e.g., one hour). In this scenario, the system may send an alert to the manager or administrator, informing them that their employee has been inactive for a set time period.

In some implementations, the system may transmit an inactivity alert to a user of the first user device in accordance with an inactivity criterion based at least on a number of interactions detected in a time period. For example, if the system determines that a first user (e.g., an employee) has been inactive for thirty minutes, it may send an inactivity alert to the first user reminding them of their goals or activity quotas. In some implementations, the system may wait for another time period before alerting a second user (e.g., an employer). For example, if the first user improves their activity for the next half an hour, the system may not send an alert to the second user. If the first user remains inactive, the system may send an alert to the second user (e.g., an administrator), wherein the second user may start a corrective action process, which is described in further detail below.

The Action Configuration Display 800 allows an administrator to use a ‘manual trigger’ which, if activated, can automatically send an alert to the inactive user/employee/CSR. The manual trigger alert may ask the inactive user to check in with the manager, log off, or to describe their work status and ongoing tasks. The system may determine that some inactivity alerts are false alarms (e.g., the employee simply received no calls, or the employee was asked to work on something else by the manager). The administrator can provide this feedback to the system. Over time, the system may discern which activity alerts are legitimate based on its data of prior false alarms.

The score threshold alert may be displayed if a user does not meet a desired score threshold for keywords mentioned during one or more interactions. For example, if a user mentions less than half of the keywords from a transcript, the system may alert the administrator. The system may also transmit a score threshold alert to a user of the first user device (e.g., an employee) in accordance with a score criterion based at least on an aggregate measure of determined interaction scores for a time period. For example, if the system determines that a first user “failed” the majority of their interactions over the time period of three days, it may send a score threshold alert to the first user reminding them of their goals or quotas. In some implementations, the system may wait for another time period before alerting a second user (e.g., an employer). If the first user improves their interaction scores and pass rate for the next four days, the system may not send an alert to the second user. If the first user's interaction performance continues to decline, or fail interaction tests, the system may send an alert to the second user, wherein the second user may start a corrective action process, which is described in further detail below.

Based on the results determined from the Action Configuration Display 800, the interaction evaluation system 100 may be programmed to automatically take a responsive action. A system response may include a corrective action, e.g., by automatically sending corrective suggestions or messages to a first user/CSR on a first user device 210. In another implementation, a system response may automatically suggest solutions to a second user/administrator on a second user device 280 for improving interaction outcomes. The system may suggest that the CSR should use more keywords during conversation or that the CSR should engage in more interactions per day. Alternatively, the system may suggest new keywords that could improve customer receptivity to a specific product, or it may provide feedback on CSR tone towards customers during interaction. The system may provide a variety of other feedback. The system may allow the administrator to decide whether to send a corrective action to a first user on a first user device based on the feedback received. Sometimes, an administrator may elect to speak to their employee in person regarding a corrective action. In this scenario, the system may generate a series of discussion points for the administrator summarizing the feedback and recommended corrective action(s). Alternatively, the system may prepare a generated message summarizing the feedback to send to the first user, which the administrator can choose to send to the CSR/employee/second user. In some implementations, the Action Configuration Display 800 may configure real-time feedback, e.g., voice feedback to an employee, either during or after an interaction. Overall, the Action Configuration Display 800 is a flexible, interactive feedback tool, as administrators can define different rules and thresholds for underperformance.

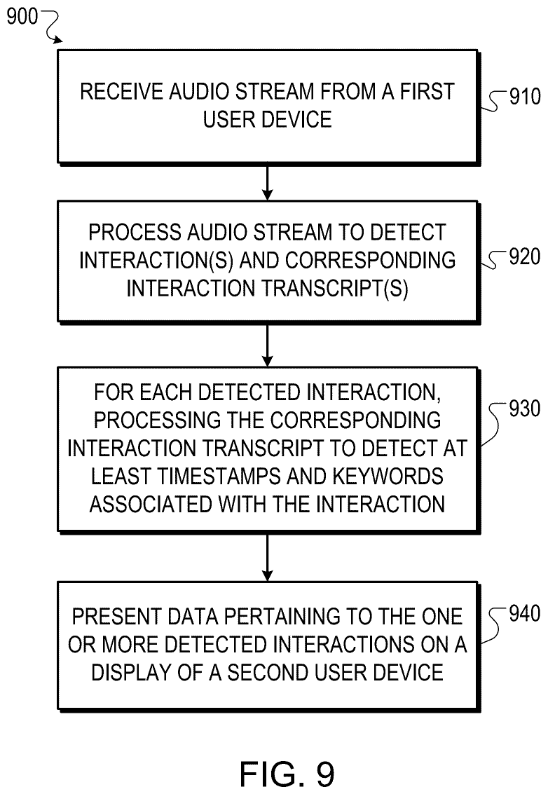

FIG. 9 is a flow diagram of an example process for detecting and evaluating an interaction. For convenience, the process 900 will be described as being performed by a system of one or more computers located in one or more locations. For example, an interaction evaluation system, e.g., the interaction evaluation system 200 of FIG. 2, appropriately programmed in accordance with this specification, can perform the process 900. As shown, the process 900 may first receive an audio stream from a first user device 910 and then process the audio stream to detect interaction(s) and corresponding interaction transcript(s) 920. For each detected interaction, the system(s) process the corresponding interaction transcript to detect at least timestamps and keywords associated with the interaction 930. Finally, the system may present data pertaining to the one or more interaction(s) on a display of a second user device.

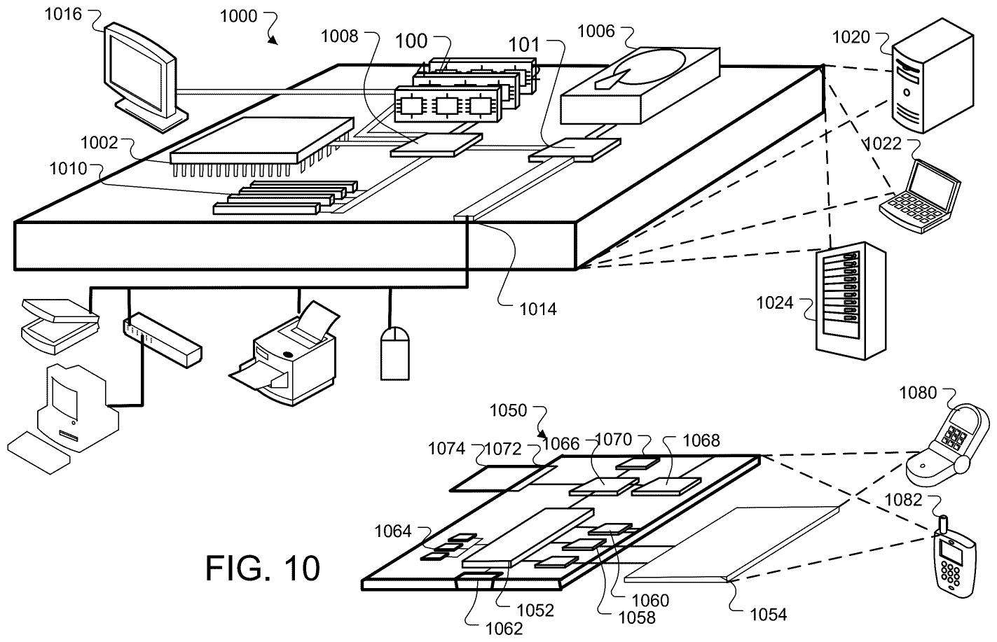

FIG. 10 illustrates an example of a computing device and a mobile computing device that can be used to implement the techniques described here.

FIG. 10 shows an example of example computer device 1000 and example mobile computer device 1050, which can be used to implement the techniques described herein. For example, a portion or all of the operations for detecting and analyzing interactions in an audio stream, etc. may be executed by the computer device 1000 and/or the mobile computer device 1050. Computing device 1000 is intended to represent various forms of digital computers, including, e.g., laptops, desktops, workstations, personal digital assistants, servers, blade servers, mainframes, and other appropriate computers. Computing device 1050 is intended to represent various forms of mobile devices, including, e.g., personal digital assistants, tablet computing devices, cellular telephones, smartphones, and other similar computing devices. The components shown here, their connections and relationships, and their functions, are meant to be examples only, and are not meant to limit implementations of the techniques described and/or claimed in this document.

Computing device 1000 includes processor 1002, memory 1004, storage device 1006, high-speed interface 1008 connecting to memory 1004 and high-speed expansion ports 1010, and low-speed interface 1012 connecting to low-speed bus 1014 and storage device 1006. Each of components 1002, 1004, 1006, 1008, 1010, and 1012, are interconnected using various busses, and can be mounted on a common motherboard or in other manners as appropriate. Processor 1002 can process instructions for execution within computing device 1000, including instructions stored in memory 1004 or on storage device 1006 to display graphical data for a GUI on an external input/output device, including, e.g., display 1016 coupled to high-speed interface 1008. In other implementations, multiple processors and/or multiple busses can be used, as appropriate, along with multiple memories and types of memory. Also, multiple computing devices 1000 can be connected, with each device providing portions of the necessary operations (e.g., as a server bank, a group of blade servers, or a multi-processor system).

Memory 1004 stores data within computing device 1000. In one implementation, memory 1004 is a volatile memory unit or units. In another implementation, memory 1004 is a non-volatile memory unit or units. Memory 1004 also can be another form of computer-readable medium (e.g., a magnetic or optical disk. Memory 1004 may be non-transitory.)

Storage device 1006 is capable of providing mass storage for computing device 1000. In one implementation, storage device 1006 can be or contain a computer-readable medium (e.g., a floppy disk device, a hard disk device, an optical disk device, or a tape device, a flash memory or other similar solid state memory device, or an array of devices, such as devices in a storage area network or other configurations.) A computer program product can be tangibly embodied in a data carrier. The computer program product also can contain instructions that, when executed, perform one or more methods (e.g., those described above.) The data carrier is a computer- or machine-readable medium, (e.g., memory 1004, storage device 1006, memory on processor 1002, and the like.)

High-speed controller 1008 manages bandwidth-intensive operations for computing device 1000, while low-speed controller 1012 manages lower bandwidth-intensive operations. Such allocation of functions is an example only. In one implementation, high-speed controller 1008 is coupled to memory 1004, display 1016 (e.g., through a graphics processor or accelerator), and to high-speed expansion ports 1010, which can accept various expansion cards (not shown). In the implementation, low-speed controller 1012 is coupled to storage device 1006 and low-speed expansion port 1014. The low-speed expansion port, which can include various communication ports (e.g., USB, Bluetooth®, Ethernet, wireless Ethernet), can be coupled to one or more input/output devices, (e.g., a keyboard, a pointing device, a scanner, or a networking device including a switch or router, e.g., through a network adapter.)

Computing device 1000 can be implemented in a number of different forms, as shown in the figure. For example, it can be implemented as standard server 1020, or multiple times in a group of such servers. It also can be implemented as part of rack server system 1024. In addition or as an alternative, it can be implemented in a personal computer (e.g., laptop computer 1022.) In some examples, components from computing device 1000 can be combined with other components in a mobile device (not shown), e.g., device 1050. Each of such devices can contain one or more of computing device 1000, 1050, and an entire system can be made up of multiple computing devices 1000, 1050 communicating with each other.

Computing device 1050 includes processor 1052, memory 1064, an input/output device (e.g., display 1054, communication interface 1066, and transceiver 1068) among other components. Device 1050 also can be provided with a storage device, (e.g., a microdrive or other device) to provide additional storage. Each of components 1050, 1052, 1064, 1054, 1066, and 1068, are interconnected using various buses, and several of the components can be mounted on a common motherboard or in other manners as appropriate.

Processor 1052 can execute instructions within computing device 1050, including instructions stored in memory 1064. The processor can be implemented as a chipset of chips that include separate and multiple analog and digital processors. The processor can provide, for example, for coordination of the other components of device 1050, e.g., control of user interfaces, applications run by device 1050, and wireless communication by device 1050.

Processor 1052 can communicate with a user through control interface 1058 and display interface 1056 coupled to display 1054. Display 1054 can be, for example, a TFT LCD (Thin-Film-Transistor Liquid Crystal Display) or an OLED (Organic Light Emitting Diode) display, or other appropriate display technology. Display interface 1056 can comprise appropriate circuitry for driving display 1054 to present graphical and other data to a user. Control interface 1058 can receive commands from a user and convert them for submission to processor 1052. In addition, external interface 1062 can communicate with processor 1042, so as to enable near area communication of device 1050 with other devices. External interface 1062 can provide, for example, for wired communication in some implementations, or for wireless communication in other implementations, and multiple interfaces also can be used.

Memory 1064 stores data within computing device 1050. Memory 1064 can be implemented as one or more of a computer-readable medium or media, a volatile memory unit or units, or a non-volatile memory unit or units. Expansion memory 1074 also can be provided and connected to device 1050 through expansion interface 1072, which can include, for example, a SIMM (Single In Line Memory Module) card interface. Such expansion memory 1074 can provide extra storage space for device 1050, or also can store applications or other data for device 1050. Specifically, expansion memory 1074 can include instructions to carry out or supplement the processes described above and can include secure data also. Thus, for example, expansion memory 1074 can be provided as a security module for device 1050 and can be programmed with instructions that permit secure use of device 1050. In addition, secure applications can be provided through the SIMM cards, along with additional data, (e.g., placing identifying data on the SIMM card in a non-hackable manner.)

The memory 1064 can include, for example, flash memory and/or NVRAM memory, as discussed below. In one implementation, a computer program product is tangibly embodied in a data carrier. The computer program product contains instructions that, when executed, perform one or more methods, e.g., those described above. The data carrier is a computer- or machine-readable medium (e.g., memory 1064, expansion memory 1074, and/or memory on processor 1052), which can be received, for example, over transceiver 1068 or external interface 1062.

Device 1050 can communicate wirelessly through communication interface 1066, which can include digital signal processing circuitry where necessary. Communication interface 1066 can provide for communications under various modes or protocols (e.g., GSM voice calls, SMS, EMS, or MMS messaging, CDMA, TDMA, PDC, WCDMA, CDMA2000, or GPRS, among others.) Such communication can occur, for example, through radio-frequency transceiver 1068. In addition, short-range communication can occur, e.g., using a Bluetooth®, WiFi, or other such transceiver (not shown). In addition, GPS (Global Positioning System) receiver module 1070 can provide additional navigation- and location-related wireless data to device 1050, which can be used as appropriate by applications running on device 1050. Sensors and modules such as cameras, microphones, compasses, accelerators (for orientation sensing), etc. may be included in the device.

Device 1050 also can communicate audibly using audio codec 1060, which can receive spoken data from a user and convert it to usable digital data. Audio codec 1060 can likewise generate audible sound for a user, (e.g., through a speaker in a handset of device 1050.) Such sound can include sound from voice telephone calls, can include recorded sound (e.g., voice messages, music files, and the like) and also can include sound generated by applications operating on device 1050.

Computing device 1050 can be implemented in a number of different forms, as shown in the figure. For example, it can be implemented as cellular telephone 1080. It also can be implemented as part of smartphone 1082, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor. The programmable processor can be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms machine-readable medium and computer-readable medium refer to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a device for displaying data to the user (e.g., a CRT (cathode ray tube) or LCD (liquid crystal display) monitor), and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a backend component (e.g., as a data server), or that includes a middleware component (e.g., an application server), or that includes a frontend component (e.g., a client computer having a user interface or a Web browser through which a user can interact with an implementation of the systems and techniques described here), or a combination of such back end, middleware, or frontend components. The components of the system can be interconnected by a form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the engines described herein can be separated, combined or incorporated into a single or combined engine. The engines depicted in the figures are not intended to limit the systems described here to the software architectures shown in the figures.

Although the present invention is defined in the attached claims, it should be understood that the present invention can also be defined in accordance with the following embodiments:

In a first embodiment, the system comprises transmitting an inactivity alert to a user of the first user device in accordance with an inactivity criterion based at least on a number of interactions detected in a time period.

In a second embodiment, the system further comprises transmitting a score threshold alert to a user of the first user device in accordance with a score criterion based at least on an aggregate measure of determined interaction scores for a time period.

In a third embodiment, each interaction evaluated by the system is between a user of the first user device and another individual.

In a fourth embodiment, the system comprises, for each interaction: 1) determining a sentiment of the other individual for the interaction, and 2) determining a score for the interaction based at least on the sentiment of the other individual.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

1. A computing-device implemented method comprising:
receiving an audio stream from a first user device that represents a user of the user device serially conversing with a sequence of individuals;
processing the audio stream to produce a transcript of the audio stream;
for the user and a first individual included in the sequence of individuals:
detecting a relevant interaction having a first interaction type and being present in an interaction transcript of the transcript, wherein an interaction between the user and the first individual having a second interaction type different from the first interaction type is net considered a relevant interaction, and wherein detecting the relevant interaction present in the transcript comprises:
processing, using a language processing model, the transcript and an interaction detection prompt comprising an instruction to detect a relevant interaction in accordance with an interaction template for the first interaction type to identify the interaction transcript corresponding with the relevant interaction, wherein processing comprises:
excluding, using the language processing model, any interaction between the user and the first individual having an irrelevant interaction type absent content present in the interaction template; and
identifying, using the language processing model, a phrase corresponding to a beginning of the relevant interaction represented in the interaction transcript corresponding with the relevant interaction and a phrase corresponding to an ending of the relevant interaction represented in the interaction transcript corresponding with the relevant interaction, wherein at least one of the identified phrases is a variation of a phrase in the interaction template; and
for each relevant interaction detected in the transcript:
processing the interaction transcript to identify at least two timestamps specifying the beginning and the ending of the relevant interaction and one or more keywords associated with the first interaction type; and
presenting for evaluation, on a display of a second user device, data pertaining to each detected relevant interaction.

2. The computing-device implemented method of claim 1, wherein receiving the audio stream from the first user device that represents a user of the user device serially conversing with a sequence of individuals comprises:
receiving one or more segments of an audio stream at a predefined cadence from the first user device; and
caching the one or more segments of the audio stream in a buffer.

3. The computing-device implemented method of claim 2, further comprising initiating transmission of the cached audio segments from the buffer to a database of cached audio segments.

4. The computing-device implemented method of claim 1, wherein processing the audio stream to produce a transcript of the audio stream comprises:
processing an audio segment received from the first user device using an audio transcription model to generate the transcript.

5. The computing-device implemented method of claim 1, wherein processing the interaction transcript to identify at least two timestamps specifying the beginning and the ending of the relevant interaction and one or more other keywords associated with the first interaction type comprises, for each relevant interaction detected in the transcript:
determining a first and second timestamp of the relevant interaction by using the language processing model to process the transcript and the corresponding interaction transcript; and
identifying the one or more keywords in the interaction transcript by using the language processing model to process the corresponding interaction transcript, the first and second timestamp of the interaction, and a set of example keywords from the interaction template for the first interaction type.

6. (canceled)

7. The computing-device implemented method of claim 1, further comprising, for each relevant interaction detected in the transcript:
determining whether the interaction transcript comprises at least one keyword of a set of example keywords for the first interaction type;
in response to determining that the interaction transcript comprises at least one keyword, identifying an interaction audio clip comprising a portion of the audio stream that pertains to the interaction; and
storing the interaction transcript, at least two timestamps, at least one keyword, and the interaction audio clip in an interaction database.

8. The computing-device implemented method of claim 1, further comprising:
determining a score for each detected relevant interaction, wherein the score is indicative of a discrepancy between contents of the interaction transcript and contents of the interaction template associated with the first interaction type.

9. The computing-device implemented method of claim 1, wherein presenting for evaluation, on a display of the second user device, data pertaining to each detected relevant interaction comprises:
presenting an identification of the user of the user device in the relevant interaction, a location of the relevant interaction, and a determined score for the relevant interaction; and
in response to an indication of a selection of a first relevant interaction by a user of the second user device, presenting an interaction display comprising the interaction transcript, at least two timestamps, and one or more other keywords for the first interaction.

10. The computing-device implemented method of claim 1, further comprising:
detecting a plurality of relevant interactions having a first interaction type from a plurality of audio streams; and
presenting for evaluation, on the display of the second user device, data pertaining to the plurality of relevant interactions.

11. The computing-device implemented method of claim 1, wherein presenting for evaluation, on the display of the second user device, data pertaining to the plurality of relevant interactions comprises:
presenting a dashboard visualization comprising one or more summary statistics for the plurality of relevant interactions; and
presenting an interaction table comprising data relating to each relevant interaction in the plurality of relevant interactions, wherein the interaction table can be filtered based on one or more criteria to present a subset of the plurality of relevant interactions.

12. A system comprising:
a computing device comprising:
a memory configured to store instructions; and
a processor to execute instructions to perform operations comprising:
receiving an audio stream from a first user device that represents a user of the user device serially conversing with a sequence of individuals;
processing the audio stream to produce a transcript of the audio stream;
for the user and a first individual included in the sequence of individuals:
detecting a relevant interaction having a first interaction type and being present in an interaction transcript of the transcript, wherein detecting the relevant interaction present in the transcript comprises:
processing, using a language processing model, the transcript and an interaction detection prompt comprising an instruction to detect a relevant interaction in accordance with an interaction template for the first interaction type to identify the interaction transcript corresponding with the relevant interaction, wherein processing comprises:
excluding, using the language processing model, any interaction between the user and the first individual having an irrelevant interaction type absent content present in the interaction template; and
identifying, using the language processing model, a phrase corresponding to a beginning of the relevant interaction represented in the interaction transcript corresponding with the relevant interaction and a phrase corresponding to an ending of the relevant interaction represented in the interaction transcript corresponding with the relevant interaction, wherein at least one of the identified phrases is a variation of a phrase in the interaction template; and
for each relevant interaction detected in the transcript:
processing the interaction transcript to identify at least two timestamps specifying the beginning and the ending of the relevant interaction and one or more keywords associated with the first interaction type; and
presenting for evaluation, on a display of a second user device, data pertaining to each detected relevant interaction.

13. The system of claim 12, wherein receiving the audio stream from the first user device that represents a user of the user device serially conversing with a sequence of individuals comprises:
receiving one or more segments of an audio stream at a predefined cadence from the first user device; and
caching the one or more segments of the audio stream in a buffer.

14. The system of claim 13, wherein operations further comprise initiating transmission of the cached audio segments from the buffer to a database of cached audio segments.

15. The system of claim 12, wherein processing the audio stream to produce a transcript of the audio stream comprises:
processing an audio segment received from the first user device using an audio transcription model to generate the transcript.

16. The system of claim 12, wherein processing the interaction transcript to identify at least two timestamps specifying the beginning and the ending of the relevant interaction and one or more other keywords associated with the first interaction type comprises, for each relevant interaction detected in the transcript:
determining a first and second timestamp of the relevant interaction by using the language processing model to process the transcript and the corresponding interaction transcript; and
identifying the one or more keywords in the interaction transcript by using the language processing model to process the corresponding interaction transcript, the first and second timestamp of the interaction, and a set of example keywords from the interaction template for the first interaction type.

17. (canceled)

18. The system of claim 12, wherein operations further comprise, for each relevant interaction detected in the transcript:
determining whether the interaction transcript comprises at least one keyword of a set of example keywords for the first interaction type;
in response to determining that the interaction transcript comprises at least one keyword, identifying an interaction audio clip comprising a portion of the audio stream that pertains to the interaction; and
storing the interaction transcript, at least two timestamps, at least one keyword, and the interaction audio clip in an interaction database.

19. The system of claim 12, wherein operations further comprise:
determining a score for each detected relevant interaction, wherein the score is indicative of a discrepancy between contents of the interaction transcript and contents of the interaction template associated with the first interaction type.

20. The system of claim 12, wherein presenting for evaluation, on a display of the second user device, data pertaining to each detected relevant interaction comprises:
presenting an identification of the user of the user device in the relevant interaction, a location of the relevant interaction, and a determined score for the relevant interaction; and
in response to an indication of a selection of a first relevant interaction by a user of the second user device, presenting an interaction display comprising the interaction transcript, at least two timestamps, and one or more other keywords for the first interaction.

21. The system of claim 12, wherein operations further comprise:
detecting a plurality of relevant interactions having a first interaction type from a plurality of audio streams; and
presenting for evaluation, on the display of the second user device, data pertaining to the plurality of relevant interactions.

22. The system of claim 12, wherein presenting for evaluation, on the display of the second user device, data pertaining to the plurality of relevant interactions comprises:
presenting a dashboard visualization comprising one or more summary statistics for the plurality of relevant interactions; and
presenting an interaction table comprising data relating to each relevant interaction in the plurality of relevant interactions, wherein the interaction table can be filtered based on one or more criteria to present a subset of the plurality of relevant interactions.

23. One or more non-transitory computer readable media storing instructions that are executable by a processing device, and upon such execution cause the processing device to perform operations comprising:
receiving an audio stream from a first user device that represents a user of the user device serially conversing with a sequence of individuals;
processing the audio stream to produce a transcript of the audio stream;
for the user and a first individual included in the sequence of individuals:
detecting a relevant interaction having a first interaction type and being present in an interaction transcript of the transcript, wherein detecting the relevant interaction present in the transcript comprises:
processing, using a language processing model, the transcript and an interaction detection prompt comprising an instruction to detect a relevant interaction in accordance with an interaction template for the first interaction type to identify the interaction transcript corresponding with the relevant interaction, wherein processing comprises:
excluding, using the language processing model, any interaction between the user and the first individual having an irrelevant interaction type absent content present in the interaction template; and
identifying, using the language processing model, a phrase corresponding to a beginning of the relevant interaction represented in the interaction transcript corresponding with the relevant interaction and a phrase corresponding to an ending of the relevant interaction represented in the interaction transcript corresponding with the relevant interaction, wherein at least one of the identified phrases is a variation of a phrase in the interaction template; and
for each relevant interaction detected in the transcript:
processing the interaction transcript to identify at least two timestamps specifying the beginning and the ending of the relevant interaction and one or more keywords associated with the first interaction type; and
presenting for evaluation, on a display of a second user device, data pertaining to each detected relevant interaction.

24. The non-transitory computer readable media of claim 23, wherein receiving the audio stream from the first user device that represents a user of the user device serially conversing with a sequence of individuals comprises:
receiving one or more segments of an audio stream at a predefined cadence from the first user device; and
caching the one or more segments of the audio stream in a buffer.

25. The non-transitory computer readable media of claim 24, wherein operations further comprise initiating transmission of the cached audio segments from the buffer to a database of cached audio segments.

26. The non-transitory computer readable media of claim 23, wherein processing the audio stream to produce a transcript of the audio stream comprises:
processing an audio segment received from the first user device using an audio transcription model to generate the transcript.

27. The non-transitory computer readable media of claim 23, wherein processing the interaction transcript to identify at least two timestamps specifying the beginning and the ending of the relevant interaction and one or more other keywords associated with the first interaction type comprises, for each relevant interaction detected in the transcript:
determining a first and second timestamp of the relevant interaction by using the language processing model to process the transcript and the corresponding interaction transcript; and
identifying the one or more keywords in the interaction transcript by using the language processing model to process the corresponding interaction transcript, the first and second timestamp of the interaction, and a set of example keywords from the interaction template for the first interaction type.

28. (canceled)

29. The non-transitory computer readable media of claim 23, wherein operations further comprise, for each relevant interaction detected in the transcript:
determining whether the interaction transcript comprises at least one keyword of a set of example keywords for the first interaction type;
in response to determining that the interaction transcript comprises at least one keyword, identifying an interaction audio clip comprising a portion of the audio stream that pertains to the interaction; and
storing the interaction transcript, at least two timestamps, at least one keyword, and the interaction audio clip in an interaction database.

30. The non-transitory computer readable media of claim 23, wherein operations further comprise:
determining a score for each detected relevant interaction, wherein the score is indicative of a discrepancy between contents of the interaction transcript and contents of a the interaction template associated with the first interaction type.

31. The computing-device implemented method of claim 1, wherein the interaction template for the first interaction type comprises one or more keywords, topics, and the phrases.

32. The computing-device implemented method of claim 1, wherein the interaction template is a member of a set of interaction templates, each interaction template defining a different relevant interaction type.

33. The system of claim 12, wherein the interaction template is a member of a set of interaction templates, each interaction template defining a different relevant interaction type.
